(19) United States
(12) Patent Application Publication
(10) Pub. No.: US 2024/0202515 A1
(43) Pub. Date: Jun. 20, 2024

(54) CLASS-INCREMENTAL LEARNING OF A CLASSIFIER

(71) Applicant: INTERNATIONAL BUSINESS MACHINES CORPORATION, ARMONK, NY (US)

(72) Inventors: Kumudu Geethan Karunaratne, Gattikon (CH); Michael Andreas Hersche, Zurich (CH); Giovanni Cherubini, Rueschlikon (CH); Abu Sebastian, Adliswil (CH); Abbas Rahimi, RUESCHLIKON (CH)

(21) Appl. No.: 18/060,987

(22) Filed: Dec. 2, 2022

(51) Int. Cl. G06N 3/08; G06N 3/0464

(52) U.S. Cl. CPC G06N 3/08; G06N 3/0464

(57) ABSTRACT

The present disclosure relates to training a classifier. The classifier includes a controller and an explicit memory. The training may include iteratively receiving one or more second training datasets, each comprising second data samples of a set of one or more associated novel classes, adding to the explicit memory one or more second output vectors indicative of the set of one or more associated novel classes, in response to providing the one or more second training datasets to the classifier, retraining the classifier using the one or more second training datasets and the first training dataset by minimizing a distance between the one or more second output vectors and the one or more prototype vectors, determining a set of updated prototype vectors indicative of first training dataset and the one or more second training datasets, and updating the explicit memory with the set of updated prototype vectors.

### BACKGROUND

The present disclosure relates to the field of digital computer systems, and more specifically, to a method for class-incremental learning of a classifier.

Continual Deep convolutional neural networks (CNNs) have achieved remarkable success in various computer vision tasks, such as image classification, stemming from the availability of large curated datasets as well as huge computational and memory resources. This, however, poses significant challenges for their applicability to smart agents deployed in new and dynamic environments, where there is a need to continually learn about novel classes from very few training samples, and under resource constraints.

### SUMMARY

Various embodiments of the disclosure are provided. Specifically, a method for continual learning of a classifier, a computer program product, and a system as described by the subject matter of the independent claims. Advantageous embodiments of the disclosure are described in the dependent claims. Embodiments of the disclosure can be freely combined with each other if they are not mutually exclusive.

In an embodiment of the disclosure, a method for continual training of a classifier is provided. The classifier includes a controller and an explicit memory. The method includes pre-training the classifier using a first training dataset that includes data samples of a set of base classes. The method includes using a set of output vectors provided by the controller in response to the controller receiving input data samples for determining a set of prototype vectors that indicate the set of base classes respectively. The controller of the classifier is configured to provide the set of output vectors indicating the base classes in response to receiving the input data samples. The method further includes storing the set of prototype vectors in the explicit memory. The method further includes iteratively: receiving a second training dataset that includes data samples of a set of second classes, adding to the explicit memory a set of output vectors that indicate the set of second classes by providing the second training dataset to the classifier, retraining the classifier using the received second training dataset and previously received training datasets using as target the prototype vectors in the explicit memory, inferring the retrained classifier using the training datasets resulting in an updated set of prototype vectors indicating the base and second classes, and updating the explicit memory with the updated set.

In another embodiment of the disclosure, a computer program product is provided. The computer program product includes a processor and a computer-readable storage medium having computer-readable program code embodied therewith. When called by the processor, the computer-readable program code is configured to cause the processor to pre-train the classifier using a first training dataset that includes data samples of a set of base classes. When called by the processor, the computer-readable program code is further configured to cause the processor to use a set of output vectors provided by the controller in response to the controller receiving input data samples for determining a set of prototype vectors that indicate the set of base classes respectively. The controller of the classifier is configured to provide the set of output vectors indicating the base classes in response to receiving the input data samples. When called by the processor, the computer-readable program code is further configured to cause the processor to store the set of prototype vectors in an explicit memory. When called by the processor, the computer-readable program code is further configured to cause the processor to iteratively: receive a second training dataset that includes data samples of a set of second classes, add to the explicit memory a set of output vectors indicating the set of second classes by providing the second training dataset to the classifier, retrain the classifier using the received second training dataset and previously received training datasets using as target the prototype vectors in the explicit memory, infer the retrained classifier using the training datasets which results in an updated set of prototype vectors that indicates the base and second classes, and update the explicit memory with the updated set.

In another embodiment of disclosure, a computer system for continual training of a classifier is provided. The classifier includes a controller and a memory, herein referred to as explicit memory. The computer system includes a processor and a computer-readable storage medium having computer-readable program code embodied therewith. When called by the processor, the computer-readable program code is configured to cause the processor to pre-train the classifier using a first training dataset that includes data samples of a set of base classes. When called by the processor, the computer-readable program code is further configured to cause the processor to use a set of output vectors provided by the controller in response to the controller receiving input data samples for determining a set of prototype vectors that indicate the set of base classes respectively. The controller of the classifier is configured to provide the set of output vectors indicating the base classes in response to receiving the input data samples. When called by the processor, the computer-readable program code is further configured to cause the processor to store the set of prototype vectors in an explicit memory. When called by the processor, the computer-readable program code is further configured to cause the processor to iteratively: receive a second training dataset that includes data samples of a set of second classes, add to the explicit memory a set of output vectors indicating the set of second classes by providing the second training dataset to the classifier, retrain the classifier using the received second training dataset and previously received training datasets using as target the prototype vectors in the explicit memory, infer the retrained classifier using the training datasets which results in an updated set of prototype vectors that indicates the base and second classes, and update the explicit memory with the updated set.

The second classes of a current second training dataset may be one or more novel classes. The novel classes are classes which were not classes of the previous first training dataset and previous zero or more second training datasets. Optionally, the second classes may comprise one or more novel classes and one or more classes of the previous first training dataset and previous zero or more second training datasets.

### BRIEF DESCRIPTION OF THE DRAWINGS

In the following, embodiments of the disclosure are explained in greater detail, by way of example only, referring to the drawings in which:

FIG. 1 illustrates a diagram of a classifier in accordance with an example of the disclosure.

FIG. 2 is a flowchart of continual training of a classifier in accordance with an example of the disclosure.

FIG. 3 is a flowchart of continual training of a classifier in accordance with an example of the disclosure.

FIG. 4 is a flowchart of continual training of a classifier in accordance with an example of the disclosure.

FIG. 5 is a diagram illustrating the stages involved in a method for few shot continual learning of a classifier according to an example of the disclosure.

FIG. 6 is a diagram illustrating the stages involved in a method for few shot continual learning of a classifier according to an example of the disclosure.

FIG. 7A depicts the status of an in-memory core during different training sessions of the classifier.

FIG. 7B is a plot of the classification accuracy using an in-memory core compared against the software accuracy.

FIG. 8 is a computing environment according to an example of the disclosure.

### DETAILED DESCRIPTION

The descriptions of the various embodiments of the present disclosure will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Classification may refer to the identification of which of a set of categories a data sample (e.g., observation) belongs to. Classification examples may include classifying a given email to the “spam” or “non-spam” class, classifying an object in an image into one of object classes. The classification may be performed by a classifier. The classifier may, for example, comprise a controller and an explicit memory. The controller may comprise a machine learning model that may be trained to classify input data samples. Thus, training the classifier comprises training the controller. The training may further comprise updating content of the explicit memory. The disclosure may enable applicability of the classifier to smart agents deployed in new and dynamic environments, because it may continually learn about novel classes from very few training samples, and under resource constraints.

The classifier may be trained using a set of training datasets [symbol] ¹, [symbol] ², . . . , [symbol] ^{s}. The training datasets [symbol] ¹, [symbol] ², . . . , [symbol] ^{s} may, for example, be received sequentially in time, e.g., the training dataset [symbol] ^{j} is received after the training dataset [symbol] ⁱ, if j>i. In order to train or re-train the classifier using a newly received training dataset, the classifier may be used to initialize the content of the explicit memory in order to represent the classes of the new training dataset by prototype vectors. For example, the first training dataset [symbol] ¹ may first be used to obtain initial output vectors of the classifier. The initial output vectors may be combined (e.g., averaged) per class to determine or derive initial prototype vectors that represent the set of base classes respectively. This stage may be referred to as “initial pass” stage. For example, the explicit memory may comprise the set of initial prototype vectors

$${P}_{o}^{1} := ( {p}_{0}^{1} , {p}_{0}^{2} , … , {p}_{0}^{\vert {𝒞}^{1} \vert} ) .$$

Moreover, the classifier may be first trained using the first training dataset [symbol] ¹. The training may be performed in accordance with a supervised learning approach. This first training may comprise a pre-training and/or meta learning. Pretraining may be done initially with some epochs using all classes in the first dataset. Meta training may be done later over a higher number of episodes. In each episode, a subset of classes and samples from those classes a randomly selected for the optimization. At the end, the classifier is pretrained and meta learned. This first training may be referred to herein as pre-training. The classifier resulting from the first training may be referred to as pre-trained classifier. The first training dataset may comprise labelled data samples of a set of base classes. For example, the first training dataset may be defined as follows:

$${𝒟}^{1} := {\{ ( {x}_{n}^{1} , {y}_{n}^{1} ) \}}_{n = 1}^{\vert {𝒟}^{1} \vert}$$

with input data samples xₙ¹ e.g., an image, and corresponding ground-truth labels yₙ¹. The labels yₙ¹ ∈ [symbol] ¹ may represent the set of base classes c=| [symbol] ¹|, where [symbol] ¹ may be the set of base classes. The total number of samples may be defined as [symbol] ¹32 c.k where k is the number of data samples per class. The first training dataset may be large enough to provide a reliable trained classifier. In particular, each base class may be provided with sufficient data samples. The number of data samples per base class in the first training dataset may be higher than a predefined minimum number kmin of data samples e.g., k>kmin. During inference, the pre-trained classifier may receive at the controller a data sample as input and may predict the class of the data sample by the controller. For that, the controller may provide an output vector of dimension d representing the class of the input data sample. The controller may provide the output vectors in a hyperdimensional embedding space whose dimensionality may remain fixed, and may therefore be independent of the number of classes in the past and future. The dimension d may, for example, be provided as d>=256 and preferably d<| [symbol] ^{s}|, where [symbol] ^{s}:=∪ⱼ₌₁^{s} [symbol] ^{j} and S is the total number of training datasets.

After pre-training the controller, the first training dataset [symbol] ¹ may be used again to infer the pre-trained controller. In particular, the input data samples of the first training dataset [symbol] ¹ may be forward propagated through the pre-trained controller. This stage may be named herein as “last pass” stage. The resulting output vectors which are provided by the controller may be used to determine or derive prototype vectors that represent each class of the set of base classes. For example, the provided output vectors for each base class may be averaged to obtain one vector which is the prototype vector of the base class. The prototype vectors

$${P}^{1} := ( {p}_{1} , {p}_{2} , … , {p}_{\vert {𝒞}^{1} \vert} )$$

may be stored in the explicit memory. The prototype vectors stored in the explicit memory may, for example, be accessed by comparing the similarities between an output query vector q of the classifier with all the prototype vectors, where said output vector q is obtained by inference of the pre-trained classifier using an input query sample. The similarity lᵢ may, for example, be defined for a given class i as follows: lᵢ=cos(tanh(q), tanh(pᵢ)). where tanh(.) is the hyperbolic tangent function and cos(.,.) the cosine similarity. Thus, the disclosure may provide a content-based attention mechanism between the controller and the explicit memory by computing a similarity score for each memory entry with respect to a given query. After training the classifier, the explicit memory may be updated with the updated prototype vectors

$${P}^{1} := ( {p}_{1} , {p}_{2} , … , {p}_{\vert {𝒞}^{1} \vert} ) .$$

Thus, upon receiving a current training dataset of current classes, the classifier may be trained by: first executing the “initial pass” stage using the current dataset to initialize the explicit memory with prototypes representing the current classes, followed by training the classifier with the current dataset, before executing the “last pass” stage to update the explicit memory using again the current dataset but also previously received datasets.

After pre-training the classifier with the first training dataset, further training datasets [symbol] ², . . . , [symbol] ^{s} named second training datasets, may be received in order to further train the classifier. The second training dataset may comprise labelled data samples of novel classes. The classes of the different training datasets may or may not be mutually exclusive across different training datasets, i.e., ∀i≠j, [symbol] ⁱ ∩ [symbol] ^{j}=∅, where [symbol] ¹ may be the set of base classes, and ∀j≠1, [symbol] ^{j} may be a set of classes which may be named second classes. The second classes [symbol] ^{j} of a given j^{th} training dataset D^{j} may be novel classes which are different from previous classes [symbol] ¹, [symbol] ² . . . and [symbol] ^{j-1} of the previous datasets D¹, D² . . . D^{j-1} respectively. Alternatively, the second classes [symbol] ^{j} of the j^{th} training dataset D^{j} may comprise novel classes in addition to classes from any one of the previous classes [symbol] ¹, [symbol] ² . . . and [symbol] ^{j-1} of the previous datasets D¹, D² . . . D^{j-1} respectively. In the following and for simplification of the description, the second classes may comprise only novel classes; however, the skilled person can implement the method accordingly for the second classes comprising novel classes and one or more of previous classes. This few shot continual learning of the classifier may enable that in any subsequent session, the classifier is prepared to deal with any number of training data samples.

For example, upon receiving the training dataset

$${𝒟}^{2} := {\{ ( {x}_{n}^{2} , {y}_{n}^{2} ) \}}_{n = 1}^{\vert {𝒟}^{2} \vert}$$

with input data samples xₙ² e.g., an image, and corresponding ground-truth labels yₙ², the explicit memory may be initialized with prototypes of the novel classes by executing the “first pass” stage. For that, the input data samples of the training dataset [symbol] ² may be provided to the controller and the resulting output vectors may be used to obtain prototypes representing the novel classes. Thus, the explicit memory may comprise prototype vectors

$${P}_{o}^{2} := ( {p}_{1} , {p}_{2} , … , {p}_{\vert {𝒞}^{1} \vert} , {p}_{0}^{1} , {p}_{0}^{2} , … , {p}_{0}^{\vert {𝒞}^{2} \vert} )$$

representing both the base and current novel classes. Pₒ² comprises the updated prototypes for the base classes [symbol] ¹ and initial prototypes for the novel classes [symbol] ². The classifier may be (re)trained using the first and second training datasets [symbol] ¹ and [symbol] ². Using all previous training datasets may solve the catastrophic forgetting issue. The retraining of the classifier may be performed using as targets the prototype vectors stored in the explicit memory. The retraining may, for example, be performed by minimizing the distance between the output vectors of a given class of the controller and the corresponding prototype vectors of the explicit memory.

After being retrained, the classifier may be inferred with the training dataset [symbol] ² and previous training dataset [symbol] ¹ so that the output vectors of each class may be averaged and stored in the explicit memory as prototype vectors of the classes. The explicit memory may thus comprise the set of prototype vectors

$${P}^{2} := ( {p}_{1} , {p}_{2} , … , {p}_{\vert {\tilde{𝒞}}^{2} \vert} ) ,$$

where [symbol] ²:=∪ⱼ₌₁² [symbol] ^{j}.

Further training datasets may be received and may be processed as described above with reference to the dataset [symbol] ². In particular, for each received s^{th} training dataset

$${𝒟}^{s} := {\{ ( {x}_{n}^{s} , {y}_{n}^{s} ) \}}_{n = 1}^{\vert {𝒟}^{s} \vert}$$

representing classes [symbol] ^{s}, the classifier may be (re)trained using the training dataset [symbol] ^{s} as described in the following.

The explicit memory may be initialized with prototypes representing the current classes [symbol] ^{s} in the explicit memory. For that, the “initial pass” stage may be executed using the current dataset [symbol] ^{s}. This may result in the explicit memory having prototypes

$${P}_{o}^{s} := ( {p}_{1} , {p}_{2} , … , {p}_{\vert {\tilde{𝒞}}^{s - 1} \vert} , {p}_{0}^{1} , {p}_{0}^{2} , … , {p}_{0}^{\vert {𝒞}^{s} \vert} )$$

representing all classes [symbol] ^{s}. Pₒ^{s} comprises the updated prototypes for all previous classes [symbol] ^{s-1} and initial prototypes for the current novel classes [symbol] ^{s}. The retraining of the classifier may be performed using as targets the prototype vectors stored in the explicit memory. The retraining may, for example, be performed using the current dataset [symbol] ^{s} and further using the previously received training datasets [symbol] ¹ to [symbol] ^{s-1} by minimizing the distance between the output vectors of a given class of the controller and the corresponding prototype vectors of the explicit memory. After being retrained, the “last pass” stage may be executed. For that, the classifier may be inferred with the training dataset [symbol] ^{s} and previous training dataset [symbol] ¹ to [symbol] ^{s-1}, wherein the output vectors of each class may be averaged and stored in the explicit memory as prototype vectors of the classes. The explicit memory may thus comprise the set of updated prototype vectors

$${P}^{s} : = ( {p}_{1} , {p}_{2} , … , {p}_{\vert {\overline{𝒞}}^{s} \vert} ) ,$$

where [symbol] ^{s}:=∪ⱼ₌₁^{s} [symbol] ^{s}. The disclosure may thus enable a linear growth in the explicit memory size with respect to the encountered classes.

In an example, the controller may include a feature extractor and a classification head. The feature extractor may map the data samples from an input domain X to a feature space: f_{θ}_{₁}:X→ [symbol] ^{d}^{_{f}}, where θ₁ are the feature extractor's learnable parameters. The feature extractor is connected to the classification head according to g_{θ}_{₂}: [symbol] ^{d}^{_{f}}→ [symbol] ^{d} containing trainable parameters θ₂ ∈ [symbol] ^{d×d}^{_{f}}. Thus, for an input data sample xᵢ of a class i, the feature extractor may provide an extracted feature vector f_{θ}_{₁}(xᵢ). The feature vectors of each class i may be averaged to obtain an activation vector aᵢ. The activation vector aᵢ may be received as input at the classification head and therefrom the classification head may provide an output vector kᵢ which indicates the class i. During retraining the feature extractor may be frozen so that the classification head may be retrained using the activation vectors provided by the frozen feature extractor for all classes received and processed so far.

Thus, the pre-trained controller may comprise a pre-trained feature extractor and pre-trained classification head. Providing the controller with two independent components may enable a flexible retraining of the controller. For example, the retraining of the controller may comprise retraining only one component while freezing the other component. According to one embodiment, the feature extractor may be frozen and the classification head may be retrained using the further received training datasets [symbol] ², . . . , [symbol] ^{s}.

In an example, an extra memory may be provided. The extra memory may be configured to store for each class i the averaged activation vector aᵢ. The usage of the extra memory may avoid additional computation performed on the frozen feature extractor and additional storage that would have taken to store the input samples to the feature extractor which may generally be larger in size than the averaged embedding vectors to the classification head. The activation vector aᵢ may be d_{f}-dimensional compressed vector that represents the globally averaged activations of class i, and may allow the determination of the corresponding prototype using g_{θ}_{₂} (.). Thus, the extra memory may be referred to as globally averaged activation memory (GAAM). The GAMM may enable to keep track of all past averaged activations e.g., for a currently processed training dataset [symbol] ^{s}, the GAMM may comprise the averaged activations

$${A}^{s} : = ( {a}_{1} , {a}_{2} , … , {a}_{\vert {\overline{𝒞}}^{s} \vert} ) .$$

For example, for each received s^{th} training dataset

$${𝒟}^{s} := {\{ ( {x}_{n}^{s} , {y}_{n}^{s} ) \}}_{n = 1}^{\vert {𝒟}^{s} \vert} ,$$

the feature extractor may be inferred with the input data samples xₙ^{s} and thus provide an extracted feature vector f_{θ}_{₁}(xₙ^{s}). The feature vectors of each class i of the set of novel classes [symbol] ^{s} may be averaged to obtain an activation vector aᵢ. The activation vectors

$${a}_{1} , {a}_{2} , … , {a}_{\vert {\overline{𝒞}}^{s} \vert}$$

may be stored in the GAAM. The classification head may be retrained by using as input all the activation vectors in the GAAM,

$${A}^{s} : = ( {a}_{1} , {a}_{2} , … , {a}_{\vert {\overline{𝒞}}^{s} \vert} )$$

which represent all classes received so far.

In case the feature extractor is not frozen, the content of the GAAM may be initialized and updated with the averaged activation vectors in a similar way as the explicit memory. For example, for a current s^{th} training dataset

$${𝒟}^{s} := {\{ ( {x}_{n}^{s} , {y}_{n}^{s} ) \}}_{n = 1}^{\vert {𝒟}^{s} \vert}$$

representing classes [symbol] ^{s}, the GAAM may be initialized with activation vectors representing the current classes [symbol] ^{s}. For that, during the “initial pass” stage execution, the current dataset [symbol] ^{s} is provided as input to the feature extractor. The outputs of the feature extractor representing each class may be averaged to obtain the corresponding activation vector. This may result in the GAAM having activation vectors representing all classes [symbol] ^{s}. After retraining the classifier, the GAAM may be updated during the execution of the “last pass” stage where the feature extractor is inferred with the training dataset [symbol] ^{s} and previous training dataset [symbol] ¹ to [symbol] ^{s-1}, wherein the output vectors of each class may be averaged and stored in the GAAM as activation vector of the class. The GAAM may thus comprise the set of activation vectors for all classes: [symbol] ^{s}:=∪ⱼ₌₁^{s} [symbol] ^{s}. If the feature extractor is frozen, the initial content of the GAAM may be the optimal one e.g., executing the “last pass” stage may not change the initial content of the GAAM. In this case, the execution of the “last pass” may use the activation vectors which are currently stored in the GAAM and provide them as inputs to the classification head.

The retraining of the classification head may be performed by using a set of target prototype vectors K*. For a current training dataset, the target prototype vectors may, for example, be derived from the prototype vectors

$${P}_{o}^{s} : = ( {p}_{1} , {p}_{2} , … , {p}_{\vert {\overline{𝒞}}^{s - 1} \vert} , {p}_{0}^{1} , {p}_{0}^{2} , … , {p}_{0}^{\vert {𝒞}^{s} \vert} )$$

of the explicit memory. In one example, K*=Pₒ^{s}. In another example, the target prototype vectors may be provided to create separation between nearby prototype pairs, which may optimally yield close to zero cross-correlation between the prototype pairs. A computationally cheap yet effective option may be to add some sort of noise to the prototypes Pₒ^{s}, e.g., quantization noise. For example, the prototypes Pₒ^{s} may be quantized to bipolar vectors by applying the element-wise sign operation, to obtain the targets K*=sign(Pₒ^{s}). The classification head may be retrained such that its output aligns with the bipolarized prototypes K*. Instead of attempting to optimize every training sample, this may allow to align the globally averaged activations available in the GAAM with the bipolarized prototypes K*. The classification head may have the task of mapping localist features from the feature extractor to a distributed representation. Thus, updating the parameters θ₂ of the classification head may be sufficient, while the parameters θ₁ of the feature extraction may be kept frozen during retraining. Due to the averaged prototype-based retraining and the linearity of the classification head, it may be sufficient to pass the averaged activations from the GAAM through the fully connected layer.

The retraining of the classification head may be performed such that a distance between output vectors of the classification head and corresponding prototype vectors in the explicit memory is minimized. For that, the minimization may be performed using the following equation over a number T of iterations:

$${θ}_{2}^{( t + 1 )} = {θ}_{2}^{( t )} - β \frac{\partial ( {ℒ}_{F} ( {θ}_{2}^{( t )} , {K}^{*} , {A}^{s} ) )}{\partial {θ}_{2}^{( t )}} ,$$

where [symbol] _{F}=−Σᵢ₌₁^{c}sₕ(kᵢ*, g_{θ}_{₂}_{^{(t)}}(aᵢ), where kᵢ* is the prototype vector stored in the explicit memory in association with the i^{th} class, aᵢ is the input vector of the classification head for the i^{th} class.

After retraining of the classification head, the explicit memory may be updated. In particular, after T iterations of parameter updates, the final prototype vectors P^{s} are determined by passing the globally averaged activations A^{s} through the retrained classification head one last time to obtain final prototype vectors as follows: pᵢ*=g_{θ}_{₂}_{^{(T)}}(aᵢ).

In an example, the feature extractor comprises non linear layers of a CNN and the classification head comprises a fully connected layer of the CNN. The classification head may be the final fully connected layer of the CNN. The connection of the feature extractor to the fully connected layer may enable to form an embedding network with a hyperdimensional distributed representation.

In an example, the target prototype vectors K* may be provided as nudged prototype vectors. This may provide improved prototype alignment strategy based on solving an optimization problem instead of simply bipolarizing the prototypes by K*=sign(Pₒ^{s}). The nudged prototype vectors may be provided such that they simultaneously a) improve the inter-class separability by attaining a lower similarity between the pairs of nudged prototype vectors, and b) remain close to the initial averaged prototype vectors P^{s}.

To obtain the nudged prototype vectors from the current prototype vectors P^{s} stored in the extra memory, the initial nudged prototype vectors may be initialized to the current prototype vectors as follows: K*⁽⁰⁾=Pₒ^{s}. The nudged prototype vectors are then updated U times in a training loop to find an optimal set of nudged prototype vectors unique to the given A^{s} available in the GAAM. The updates to the nudged prototype vectors may be based on two distinct loss functions that aim to meet the two aforementioned objectives. The first main objective may be to decrease the inter-class similarity, which may be achieved by minimizing the cross-correlation between the prototypes. In particular, the nudged prototype vectors may be updated using backpropagation on the standard gradient descent algorithm given as:

$${k}_{i}^{* ( u + 1 )} = {k}_{i}^{* ( u )} - α \frac{\partial ( {ℒ}_{O} ( {{K}^{*}}^{u} ) ) + \partial ( {L}_{M} ( {{K}^{*}}^{u} , P ) )}{\partial {k}_{i}^{* ( u )}} ,$$

where [symbol] _{O}=Σ_{i,j=1;i≠j}^{c}exp(sₕ(kᵢ*^{(U)}, kᵢ*^{(U)})) and [symbol] _{M}=−Σᵢ₌₁^{c}sₕ(kᵢ*^{(U)}, pᵢ), where kᵢ*^{(u)} is the quasi-orthogonal prototype vector obtained in iteration number u for the i^{th} class, and pᵢ is the prototype vector stored in the explicit memory in association with the i^{th} class, and sₕ denotes a soft hamming distance. The final nudged prototype vectors K*:=K*^{(U)} may thus be used as targets to retrain the classification head for T iterations.

The second objective to keep the updated prototypes similar to the initial prototypes K*⁽⁰⁾ may be enabled by the second loss function [symbol] _{M}. This may avoid significant deviations from the original representations of the initial base categories on which the classifier was trained.

In an example, an in-memory computing core is provided. The in-memory computing core includes a crossbar array structure comprising row lines and column lines and resistive memory elements coupled between the row lines and the column lines at junctions formed by the row and column lines, programming the resistive memory elements of each column line to represent the values of the respective prototype vectors of the explicit memory, inputting to the crossbar array the query vector for performing the similarity search.

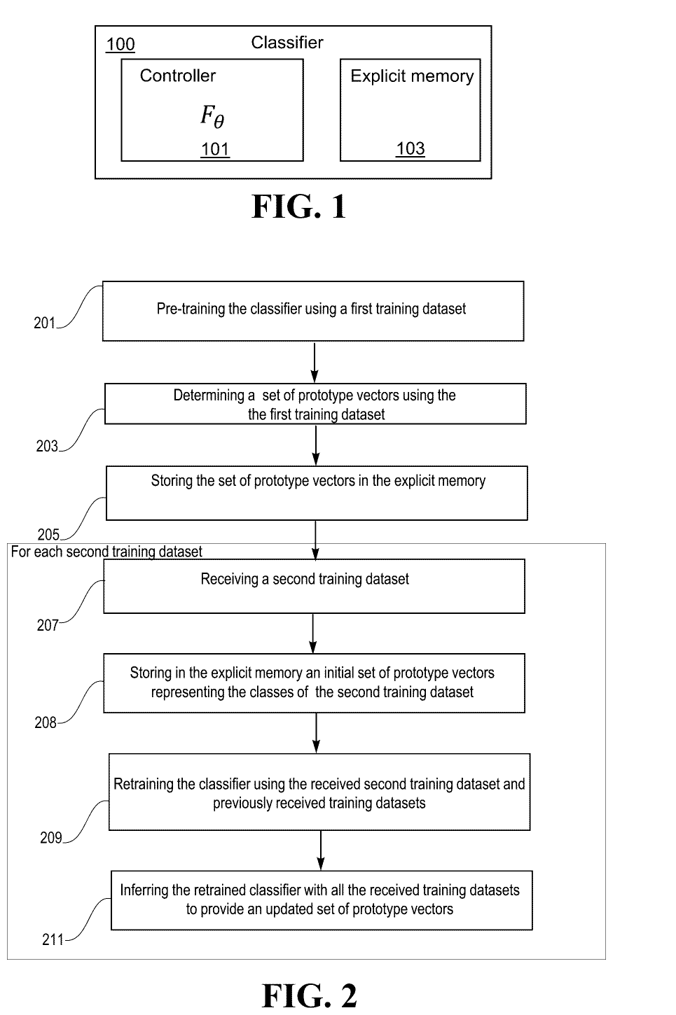

FIG. 1 is a diagram showing a classifier according to one or more embodiments of the disclosure. The classifier 100 includes a controller 101 and an explicit memory 103. The controller 101 may be trained using a training dataset

$${𝒟}^{s} := {\{ ( {x}_{n}^{s} , {y}_{n}^{s} ) \}}_{n = 1}^{\vert {𝒟}^{s} \vert} .$$

The controller 101 may, for example, be defined by a set of trainable parameters θ. The controller 101 may thus be said as implementing a function or model F_{θ}, where for each input data sample xₙ^{s}, the controller may provide an output vector F_{θ}(xₙ^{s}) of dimension d. For each input data sample xₙ^{s} of a given class i, the controller 101 may provide an output vector kₙⁱ that indicates or represents the class i. Those output vectors kₙⁱ that belong to the same class i may be averaged to obtain the prototype vector pᵢ. The set of prototype vectors P^{s} may be stored in the explicit memory 103. Those prototype vectors may be used as targets for further training the controller 101.

FIG. 2 is a flowchart of a method for continual training of a classifier comprising a controller and a memory. The method of FIG. 2 may be described with reference to FIG. 1, but it is not limited to that implementation of FIG. 1. A set of training datasets [symbol] ¹, [symbol] ², . . . , [symbol] ^{s} may be received and used fort training the classifier 100 as follows.

The explicit memory 103 may be initialized with a set of prototype vectors

$${P}_{0}^{1} := ( {p}_{0}^{1} , {p}_{0}^{2} , … , {p}_{0}^{\vert {𝒞}^{1} \vert} )$$

using a first training dataset [symbol] ¹. Alternatively, the set of prototype vectors P₀¹ may be user defined. The classifier may be pre-trained in stage 201 using the first training dataset [symbol] ¹. The first training dataset may comprise data samples such as images of a set of base classes. The first training dataset may be defined as follows:

$${𝒟}^{1} := {\{ ( {x}_{n}^{1} , {y}_{n}^{1} ) \}}_{n = 1}^{\vert {𝒟}^{1} \vert}$$

with input data samples xₙ^{s} e.g., an image, and corresponding ground-truth labels yₙ¹. The labels yₙ¹ ∈ [symbol] ¹ may represent the set of base classes c=| [symbol] ¹|, where [symbol] ¹ may be the set of base classes, where the total number of samples may be defined as [symbol] ¹=c.k where k is the number of data samples per class. The number of data samples per base class in the first training dataset may be higher than a predefined minimum number kmin of data samples e.g., k>kmin. This pre-training may result in a pre-trained classifier. The training may be performed using the content of the explicit memory 103 as target. For example, the distance between output vectors of the controller 101 and the associated prototype vector of the set of prototype vectors P₀¹ may be minimized during the training to find optimal values of the set of trainable parameters θ of the controller 101.

After pre-training, an updated or optimized set of prototype vectors P¹ that represents the base classes [symbol] ¹ may be determined in stage 203. The set of prototype vectors

$${P}^{1} := ( {p}_{1} , {p}_{2} , … , {p}_{\vert {𝒞}^{1} \vert} )$$

may be obtained using the output vectors of the controller 101. For example, for each base class i, the prototype vector pi may be determined as the average of the output vectors of the controller 101 for input data samples of the base class i. For each input data sample xₙ¹ of a given base class i the pre-trained controller 101 may provide an output vector kₙⁱ that indicates or represents the base class i. This may be referred to as forward prorogation of the pre-trained controller with the data sample xₙ¹. Those output vectors kₙⁱ that belong to the same class i may be averaged to obtain the prototype vector pᵢ. The set of prototype vectors P¹ may be stored in stage 205 in the explicit memory 103 by replacing the initial set of prototype vectors P₀¹ with the updated set of prototype vectors P¹.

After pre-training the classifier with the first training dataset [symbol] ¹, further training datasets [symbol] ², . . . , [symbol] ^{s}, named second training datasets, may be received in order to further train the classifier 100. The second training dataset may comprise labelled data samples of novel classes. The classes of the different training datasets may be mutually exclusive across different training datasets, i.e., ∀i≠j, [symbol] ⁱ ∩ [symbol] ^{j}=∅, where [symbol] ¹ may be the set of base classes, and ∀j≠1, [symbol] ^{j} may be a set of novel classes. The number of data samples per novel class in the further training datasets may be smaller than the predefined minimum number kmin of data samples e.g., k<kmin. The second training datasets [symbol] ², . . . , [symbol] ^{s} may be received and/or processed successively and for each current received second training dataset [symbol] ^{s} (in stage 207) the following may be performed.

The explicit memory 103 may be initialized in stage 208 with a set of prototype vectors

$$( {p}_{0}^{1} , {p}_{0}^{2} , … , {p}_{0}^{\vert {𝒞}^{s} \vert} )$$

for the novel classes [symbol] ^{s}. These set of prototype vectors P₀^{s} obtained by executing the “initial pass” stage using the training dataset [symbol] ^{s}. The explicit memory 103 may thus comprise the optimized prototype vectors of the previous classes and the initial set of prototype vectors for the current classes [symbol] ^{s} as follows:

$${P}_{o}^{s} : = ( {p}_{1} , {p}_{2} , … , {p}_{\vert {\overline{𝒞}}^{s - 1} \vert} , {p}_{0}^{1} , {p}_{0}^{2} , … , {p}_{0}^{\vert {𝒞}^{s} \vert} ) .$$

The classifier 100 may be retrained in stage 209 using the received second dataset [symbol] ^{s} but also using previously received training datasets [symbol] ¹ . . . [symbol] ^{s-1}. The current training dataset may be defined as follows

$${𝒟}^{s} := {\{ ( {x}_{n}^{s} , {y}_{n}^{s} ) \}}_{n = 1}^{\vert {𝒟}^{s} \vert} .$$

The retraining may be performed using as target the prototype vectors

$${P}_{o}^{s} := ( {p}_{1} , {p}_{2} , … , {p}_{\vert {\tilde{𝒞}}^{s - 1} \vert} , {p}_{0}^{1} , {p}_{0}^{2} , … , {p}_{0}^{\vert {𝒞}^{s} \vert} ) ,$$

where [symbol] ^{s}:=∪ⱼ₌₁^{s} [symbol] ^{s}, in the explicit memory 103. In one example, the retraining may be performed by inputting the input data samples

$${x}_{n}^{1} , … , {x}_{n}^{\vert {𝒟}^{s} \vert}$$

of all the training datasets to the controller 101. The retraining may, for example, be performed by minimizing the distance between the output vectors of a given class of the controller and the corresponding prototype vector

$${P}_{o}^{s} := ( {p}_{1} , {p}_{2} , … , {p}_{\vert {\tilde{𝒞}}^{s - 1} \vert} , {p}_{0}^{1} , {p}_{0}^{2} , … , {p}_{0}^{\vert {𝒞}^{s} \vert} )$$

of the explicit memory 103.

The retrained classifier 100 may be inferred in stage 211 using all the received training datasets [symbol] ¹, . . . , [symbol] ^{s} to provide an updated set of prototype vectors

$${P}^{s} := ( {p}_{1} , {p}_{2} , … , {p}_{\vert {\tilde{𝒞}}^{s} \vert} ) .$$

The set of prototype vectors

$${P}^{s} := ( {p}_{1} , {p}_{2} , … , {p}_{\vert {\tilde{𝒞}}^{s} \vert} )$$

may replace the set of prototype vectors Pₒ^{s} in the explicit memory 103. For example, the inference may be performed by inputting the input data samples

$${x}_{n}^{1} , … , {x}_{n}^{\vert {𝒟}^{s} \vert}$$

of all the training datasets to the retrained controller 101 that provides respective output vectors, wherein output vectors that belong to the same class i may be averaged to obtain the prototype vector pᵢ which is stored in the explicit memory 103 to update/replace its content.

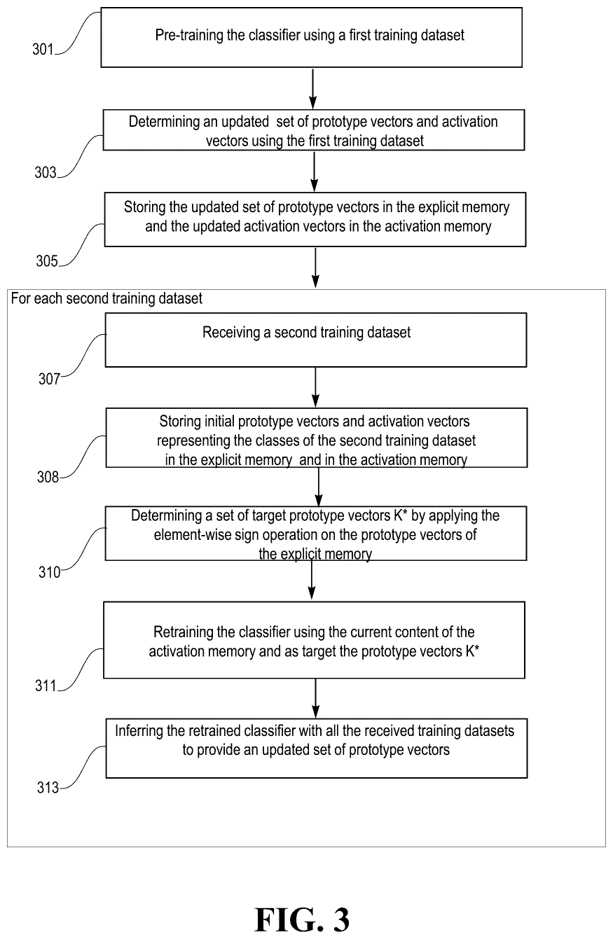

FIG. 3 is a flowchart of a method for continual training of a classifier comprising a controller and a memory. The controller may comprise a feature extractor and a classification head. The feature extractor may map the data samples from an input domain X to a feature space: f_{θ}_{₁}:X→ [symbol] ^{d}^{_{f}}, where θ₁ are the feature extractor's learnable parameters. The feature extractor is connected to the classification head according to g_{θ}_{₂}: [symbol] ^{d}^{_{f}}→ [symbol] ^{d}, containing trainable parameters θ₂ ∈ [symbol] ^{d×d}^{_{f}}. Thus, for an input data sample xᵢ of a class i, the feature extractor may provide an extracted feature vector f_{θ}_{₁}(xᵢ). The feature vectors of each class i may be averaged to obtain an activation vector aᵢ. The activation vector aᵢ may be received as input at the classification head and therefrom the classification head may provide an output vector kᵢ which indicates the class i. The classifier may further be provided with an extra memory referred to as activation memory.

The explicit memory may be initialized with a set of prototype vectors

$${P}_{0}^{1} := ( {p}_{0}^{1} , {p}_{0}^{2} , … , {p}_{0}^{\vert {𝒞}^{1} \vert} )$$

using a first training dataset [symbol] ¹. The classifier may be pre-trained in stage 301 using a first training dataset [symbol] ¹. The first training dataset may comprise data samples such as images of a set of base classes. The first training dataset may be defined as follows:

$${𝒟}^{1} := {\{ ( {x}_{n}^{1} , {y}_{n}^{1} ) \}}_{n = 1}^{\vert {𝒟}^{1} \vert}$$

with input data samples xₙ¹ e.g., an image, and corresponding ground-truth labels yₙ¹. The labels yₙ¹ ∈ [symbol] ¹ may represent a set of base classes c=| [symbol] ¹|, where [symbol] ¹ may be the set of base classes, where the total number of samples may be defined as [symbol] ¹=c.k where k is the number of data samples per class. The number of data samples per base class in the first training dataset may be higher than a predefined minimum number kmin of data samples e.g., k>kmin. This pre-training may result in a pre-trained classifier. The training may be performed using the content of the explicit memory 103 as target. For example, the distance between output vectors of the controller 101 and the associated prototype vector of the set of prototype vectors P₀¹ may be minimized during the training in order to find optimal values of the set of trainable parameters θ₁ and θ₂ of the feature extractor and classification head respectively.

After pre-training the classifier, a set of prototype vectors P¹ may be determined in stage 303 and stored in the explicit memory. The set of prototype vectors

$${P}^{1} := ( {p}_{1} , {p}_{2} , … , {p}_{\vert {𝒞}^{1} \vert} )$$

may be obtained using the output vectors of the controller (i.e., output vectors of the classification head). For example, for each base class i, the prototype vector pᵢ may be determined as the average of the output vectors of the controller for input data samples of the base class i. For each input data sample xₙ¹ of a given base class i the pre-trained controller may provide an output vector kₙⁱ that indicates or represents the base class i. Those output vectors kₙⁱ that belong to the same class i may be averaged to obtain the prototype vector pᵢ. The activation vectors representing the base classes may be determined using feature vectors of the pre-trained feature extractor. For that, the first training dataset [symbol] ¹ may be reused to infer the pre-trained feature extractor in order to provide the averaged activation vectors

$${A}^{1} := ( {a}_{1} , {a}_{2} , … , {a}_{\vert {𝒞}^{1} \vert} )$$

associated with the base classes [symbol] ¹. For example, the activation vector may be provided as follows. The pre-trained feature extractor may receive the input data samples xₙ¹ and provide corresponding extracted feature vectors f_{θ}_{₁}(xₙ¹). The feature vectors of each class i of the set of base classes [symbol] ¹ may be averaged to obtain an activation vector aᵢ. In one example, the activation vectors

$${A}^{1} := ( {a}_{1} , {a}_{2} , … , {a}_{\vert {𝒞}^{1} \vert} )$$

and the set of prototype vectors P¹ may be determined in one go, that is, the same input samples of the first training dataset my be used to provide the activation vectors and the prototype vectors.

The set of prototype vectors P¹ may be stored in stage 305 in the explicit memory and the set of activation vectors

$${A}^{1} := ( {a}_{1} , {a}_{2} , … , {a}_{\vert {𝒞}^{1} \vert} )$$

may be stored in the activation memory. The pre-trained feature extractor may be frozen for further received training datasets.

After pre-training the classifier with the first training dataset [symbol] ¹, further training datasets [symbol] ², . . . , [symbol] ^{s}, named second training datasets, may be received in order to further train the classifier. The second training dataset may comprise labelled data samples of novel classes. The classes of the different training datasets may be mutually exclusive across different training datasets, i.e., ∀i≠j, [symbol] ⁱ ∩ [symbol] ^{j}=∅, where [symbol] ¹ may be the set of base classes, and ∀j≠1, [symbol] ^{j} may be a set of novel classes. The number of data samples per novel class in the further training datasets may be smaller than the predefined minimum number kmin of data samples e.g., k<kmin. The second training datasets [symbol] ², . . . , [symbol] ^{s} may be received and/or processed successively and for each current received second training dataset [symbol] ₛ (in stage 307) the following may be performed.

The explicit memory may be initialized in stage 308 with a set of prototype vectors

$$( {p}_{0}^{1} , {p}_{0}^{2} , … , {p}_{0}^{\vert {𝒞}^{s} \vert} )$$

obtained by executing the “initial pass” stage using the training dataset [symbol] ^{s}. The explicit memory may thus comprise the optimized prototype vectors of the previous classes and the initial set of prototype vectors for the current classes as follows:

$${P}_{o}^{s} := ( {p}_{1} , {p}_{2} , … , {p}_{\vert {\tilde{𝒞}}^{s - 1} \vert} , {p}_{0}^{1} , {p}_{0}^{2} , … , {p}_{0}^{\vert {𝒞}^{s} \vert} ) .$$

The “first pass” execution may be used to update the content of the activation memory with the activation vectors representing the current novel classes. The activation memory may thus comprise the set of activation vectors

$${A}^{s} := ( {a}_{1} , {a}_{2} , … , {a}_{\vert {𝒞}^{s} \vert} ) .$$

A set of target prototype vectors may, for example, be derived in stage 310 from the current prototype vectors

$${P}_{o}^{s} := ( {p}_{1} , {p}_{2} , … , {p}_{\vert {\tilde{𝒞}}^{s - 1} \vert} , {p}_{0}^{1} , {p}_{0}^{2} , … , {p}_{0}^{\vert {𝒞}^{s} \vert} )$$

of the explicit memory. For example, the target prototype vectors may be provided by applying the element-wise sign operation to obtain the targets K*=sign(Pₒ^{s}).

The classifier may be retrained in stage 311 using the received second dataset [symbol] ^{s} but also using previously received training datasets [symbol] ¹ . . . [symbol] ^{s-1}. The retraining may be performed by inputting the activation vectors

$${A}^{s} := ( {a}_{1} , {a}_{2} , … , {a}_{\vert {𝒞}^{s} \vert} )$$

previously stored in the activation memory to the classification head. During the retraining, the classification head may receive them from the activation memory. The activation memory may be advantageous because previously produced activation vectors are reused and there is no need to produce them again through the pre-trained and frozen feature extractor.

The current training dataset may be defined as follows

$${𝒟}^{s} := {\{ ( {x}_{n}^{s} , {y}_{n}^{s} ) \}}_{n = 1}^{\vert {𝒟}^{s} \vert} .$$

The retraining may be performed by freezing the feature extractor and retraining the classification head. The retraining of the classification head may be performed by using the set of target prototype vectors K*. The retraining may, for example, be performed by minimizing the distance between the output vectors of a given class of the controller and the corresponding prototype vector in K*.

The retrained classifier may be inferred in stage 313 using all the received training datasets [symbol] ¹, . . . , [symbol] ^{s} to provide an updated set of prototype vectors

$${P}^{s} := ( {p}_{1} , {p}_{2} , … , {p}_{\vert {\tilde{𝒞}}^{s} \vert} ) .$$

For example, the inference may be performed by inputting the input data samples

$${x}_{n}^{1} , … , {x}_{n}^{\vert {𝒟}^{s} \vert}$$

of all the training datasets to the retrained controller that provides respective output vectors, wherein output vectors that belong to the same class i may be averaged to obtain the prototype vector Pᵢ. Alternatively, the activation vectors

$${A}^{s} := ( {a}_{1} , {a}_{2} , … , {a}_{\vert {𝒞}^{s} \vert} )$$

currently stored in the activation memory may be input to the retrained classification head to produce the updated set of prototype vectors

$${P}^{s} := ( {p}_{1} , {p}_{2} , … , {p}_{\vert {\tilde{𝒞}}^{s} \vert} ) .$$

The set of prototype vectors

$${P}^{s} := ( {p}_{1} , {p}_{2} , … , {p}_{\vert {\tilde{𝒞}}^{s} \vert} )$$

may replace the set of prototype vectors Pₒ^{s} in the explicit memory.

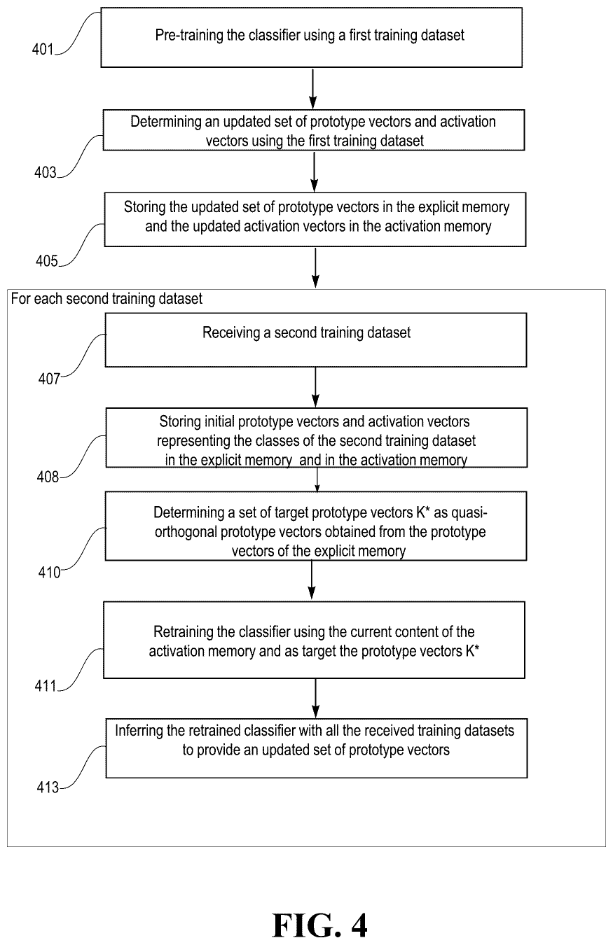

FIG. 4 is a flowchart of a method for continual training of a classifier comprising a controller and a memory. The controller may comprise a feature extractor and a classification head. The feature extractor may map the data samples from an input domain X to a feature space: f_{θ}_{₁}:X→ [symbol] ^{d}^{_{f}}, where θ₁ are the feature extractor's learnable parameters. The feature extractor is connected to the classification head according to g_{θ}_{₂}: [symbol] ^{d}^{_{f}}→ [symbol] ^{d}, containing trainable parameters θ₂ ∈ [symbol] ^{d×d}^{_{f}}. Thus, for an input data sample xᵢ of a class i, the feature extractor may provide an extracted feature vector f_{θ}_{ᵢ}(xᵢ). The feature vectors of each class i may be averaged to obtain an activation vector aᵢ. The activation vector aᵢ may be received as input at the classification head and therefrom the classification head may provide an output vector kᵢwhich indicates the class i. The classifier may further be provided with an extra memory referred to as activation memory.

The explicit memory may be initialized with a set of prototype vectors

$${P}_{0}^{1} := ( {p}_{0}^{1} , {p}_{0}^{2} , … , {p}_{0}^{\vert {𝒞}^{1} \vert} )$$

using a first training dataset [symbol] ¹. The classifier may be pre-trained in stage 401 using a first training dataset [symbol] ¹. The first training dataset may comprise data samples such as images of a set of base classes. The first training dataset may be defined as follows:

$${𝒟}^{1} := {\{ ( {x}_{n}^{1} , {y}_{n}^{1} ) \}}_{n = 1}^{\vert {𝒟}^{1} \vert}$$

with input data samples xₙ¹ e.g., an image, and corresponding ground-truth labels yₙ¹. The labels yₙ¹ ∈ [symbol] ¹ may represent a set of base classes c=| [symbol] ¹|, where [symbol] ¹ may be the set of base classes, where the total number of samples may be defined as [symbol] ¹=c.k where k is the number of data samples per class. The number of data samples per base class in the first training dataset may be higher than a predefined minimum number kmin of data samples e.g., k>kmin. This pre-training may result in a pre-trained classifier. The training may be performed using the content of the explicit memory 103 as target. For example, the distance between output vectors of the controller 101 and the associated prototype vector of the set of prototype vectors P₀¹ may be minimized during the training in order to find optimal values of the set of trainable parameters θ₁ and θ₂ of the feature extractor and classification head respectively.

After pre-training the classifier, a set of prototype vectors P¹ may be determined in stage 403 and stored in the explicit memory. The set of prototype vectors

$${P}^{1} := ( {p}_{1} , {p}_{2} , … , {p}_{\vert {𝒞}^{1} \vert} )$$

may be obtained using the output vectors of the controller. For example, for each base class i, the prototype vector pᵢ may be determined as the average of the output vectors of the controller for input data samples of the base class i. The output vectors may be obtained during the pre-training of the classifier e.g., for each input data sample xₙ¹ of a given base class i the controller may provide an output vector kₙⁱ that indicates or represents the base class i. Those output vectors kₙⁱ that belong to the same class i may be averaged to obtain the prototype vector pᵢ. The activation vectors representing the base classes may be determined using output vectors of the pre-trained feature extractor. The first training dataset [symbol] ¹ may be reused to infer the pre-trained feature extractor in order to provide the averaged activation vectors associated with the base classes. For example, the activation vector may be provided as follows. The pre-trained feature extractor may receive the input data samples xₙ¹ and provide corresponding extracted feature vectors f_{θ}_{₁}(xₙ¹). The feature vectors of each class i of the set of base classes [symbol] ¹ may be averaged to obtain an activation vector aᵢ. In one example, the activation vectors

$${A}^{1} := ( {a}_{1} , {a}_{2} , … , {a}_{\vert {𝒞}^{1} \vert} )$$

and the set of prototype vectors P¹ may be determined in one go, that is, the same input samples of the first training dataset my be used to provide the activation vectors and the prototype vectors.

The set of prototype vectors P¹ may be stored in stage 405 in the explicit memory and the set of activation vectors

$${A}^{1} := ( {a}_{1} , {a}_{2} , … , {a}_{\vert {𝒞}^{1} \vert} )$$

may be stored in the activation memory. The pre-trained feature extractor may be frozen for further received training datasets.

After pre-training the classifier with the first training dataset [symbol] ¹, further training datasets [symbol] ², . . . , [symbol] ^{s}, named second training datasets, may be received in order to further train the classifier. The second training dataset may comprise labelled data samples of novel classes. The classes of the different training datasets may be mutually exclusive across different training datasets, i.e., ∀i≠j, [symbol] ⁱ ∩ [symbol] ^{j}=∅, where [symbol] ¹ may be the set of base classes, and ∀j≠1, [symbol] ^{j} may be a set of novel classes. The number of data samples per novel class in the further training datasets may be smaller than the predefined minimum number kmin of data samples e.g., k<kmin. The second training datasets [symbol] ², . . . , [symbol] ^{s} may be received and/or processed successively and for each current received (in stage 407) second training dataset [symbol] ^{s} the following may be performed.

The explicit memory may be initialized in stage 408 with a set of prototype vectors

$$( {p}_{0}^{1} , {p}_{0}^{2} , … , {p}_{0}^{\vert {𝒞}^{s} \vert} )$$

obtained by executing the “initial pass” stage using the training dataset [symbol] ^{s}. The explicit memory may thus comprise the optimized prototype vectors of the previous classes and the initial set of prototype vectors for the current classes as follows:

$${P}_{o}^{s} := ( {p}_{1} , {p}_{2} , … , {p}_{\vert {\tilde{𝒞}}^{s} \vert} , {p}_{0}^{1} , {p}_{0}^{2} , … , {p}_{0}^{\vert {𝒞}^{s} \vert} ) .$$

The “first pass” execution may be used to update the content of the activation memory with the activation vectors representing the current novel classes. The activation memory may thus comprise the set of activation vectors

$${A}^{s} := ( {a}_{1} , {a}_{2} , … , {a}_{\vert {𝒞}^{s} \vert} ) .$$

The current training dataset may be defined as follows

$${𝒟}^{s} := {\{ ( {x}_{n}^{s} , {y}_{n}^{s} ) \}}_{n = 1}^{\vert {𝒟}^{s} \vert} .$$

A set target prototype vectors K* may be provided in stage 410 as nudged prototype vectors from the current set of prototype vectors

$${P}_{o}^{s} := ( {p}_{1} , {p}_{2} , … , {p}_{\vert {\tilde{𝒞}}^{s - 1} \vert} , {p}_{0}^{1} , {p}_{0}^{2} , … , {p}_{0}^{\vert {𝒞}^{s} \vert} ) .$$

This may provide improved prototype alignment strategy based on solving an optimization problem instead of simply bipolarizing the prototypes by K*=sign(Pₒ^{s}). The nudged prototype vectors may be provided such that they simultaneously a) improve the inter-class separability by attaining a lower similarity between the pairs of nudged prototype vectors, and b) remain close to the initial averaged prototype vectors Pₒ^{s}. To obtain the nudged prototype vectors from the current prototype vectors Pₒ^{s} stored in the extra memory, the initial nudged prototype vectors may be initialized to the current prototype vectors as follows: K*⁽⁰⁾=Pₒ^{s}. The nudged prototype vectors are then updated U times in a training loop to find an optimal set of nudged prototype vectors unique to the given A^{s} available in the GAAM. The updates to the nudged prototype vectors may be based on two distinct loss functions that aim to meet the two aforementioned objectives. The first main objective may be to decrease the inter-class similarity, which may be achieved by minimizing the cross-correlation between the prototypes. In particular, the nudged prototype vectors may be updated using backpropagation on the standard gradient descent algorithm given as:

$${k}_{i}^{* ( u + 1 )} = {k}_{i}^{* ( u )} - α \frac{\partial ( {ℒ}_{O} ( {K}^{* u} ) ) + \partial ( {ℒ}_{M} ( {K}^{* u} , P ) )}{\partial {k}_{i}^{* ( u )}} ,$$

where [symbol] _{O}=Σ_{i,j=1;i≠j}^{c}exp(sₕ(kᵢ*^{(U)}, kᵢ*^{(U)})) and [symbol] _{M}=−Σᵢ₌₁^{c}sₕ(kᵢ*^{(U)}, pᵢ), where kᵢ*^{(U)} is the quasi-orthogonal prototype vector obtained in iteration number u for the i^{th} class, and pⁱ is the prototype vector stored in the explicit memory in association with the i^{th} class, and sₕ denotes a soft hamming distance. The final nudged prototype vectors K*:=K*^{(U)} may thus be used to retrain the classification head for T iterations.

The classifier may be retrained in stage 411 using the received second dataset [symbol] ^{s} but also using previously received training datasets [symbol] ¹ . . . [symbol] ^{s-1}. The retraining may be performed by inputting the activation vectors

$${A}^{s} := ( {a}_{1} , {a}_{2} , … , {a}_{\vert {𝒞}^{s} \vert} )$$

previously stored in the activation memory to the classification head. During the retraining, the classification head may receive them from the activation memory. The activation memory may be advantageous because previously produced activation vectors are reused and there is no need to produce them again. The retraining may be performed by freezing the feature extractor and retraining the classification head. The retraining of the classification head may be performed by using the set of target prototype vectors K* which are the quasi-orthogonal prototype vectors.

The retrained classifier may be inferred in stage 413 using all the received training datasets [symbol] ¹, . . . , [symbol] ^{s} to provide an updated set of prototype vectors

$${P}^{s} := ( {p}_{1} , {p}_{2} , … , {p}_{\vert {\tilde{𝒞}}^{s} \vert} ) .$$

For example, the inference may be performed by inputting the input data samples

$${x}_{n}^{1} , … , {x}_{n}^{\vert {𝒟}^{s} \vert}$$

of all the training datasets to the retrained controller that provides respective output vectors, wherein output vectors that belong to the same class i may be averaged to obtain the prototype vector pᵢ. Alternatively, the activation vectors

$${A}^{s} := ( {a}_{1} , {a}_{2} , … , {a}_{\vert {𝒞}^{s} \vert} )$$

currently stored in the activation memory may be input to the retrained classification head to produce the updated set of prototype vectors

$${P}^{s} := ( {p}_{1} , {p}_{2} , … , {p}_{\vert {\tilde{𝒞}}^{s} \vert} ) .$$

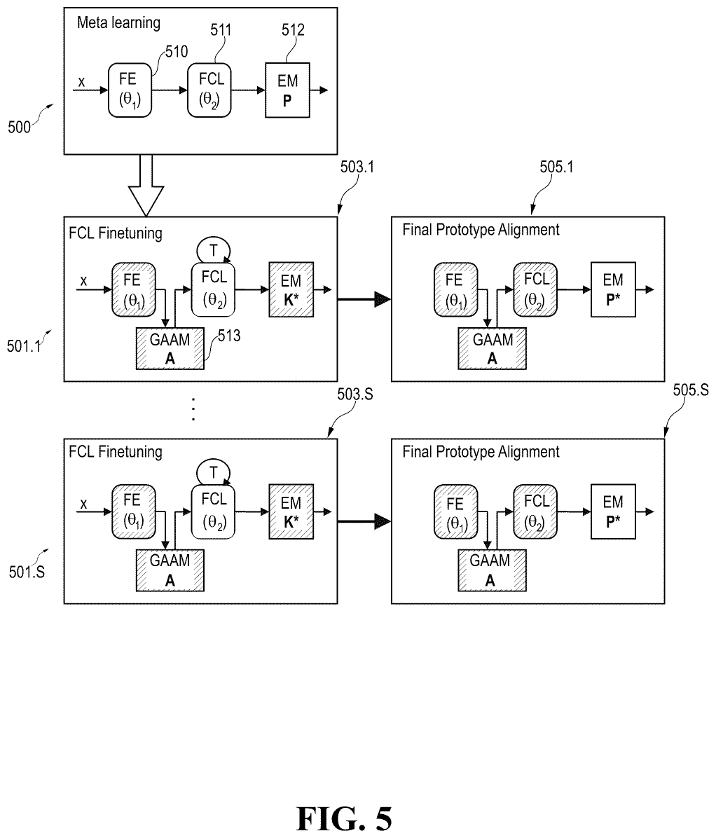

FIG. 5 is a diagram illustrating the stages involved in a method for few shot continual learning of a classifier according to an example of the disclosure.

The classifier comprises a feature extractor (FE) 510 which may be the nonlinear layers of a CNN, a final fully connected layer (FCL) 511 of the CNN and an explicit memory (EM) 512. The FE 510 may have trainable parameters θ₁. The FCL 511 may have the trainable parameters θ₂. The EM 512 may be configured to store prototype vectors representing classes. The training of the classifier according to the present example may be performed in different phases, a first phase 500 followed by a succession of phases 501.1 to 501.S. The classifier may be provided with an additional memory GAAM 513 that may be used for training in the phases 501.1 to 501.S.

In the first phase 500, the classifier may be first trained using a first training dataset [symbol] ¹ comprising data samples of a set of base classes [symbol] ¹. The first training may comprise pre-training and/or meta-learning. For example, the first training dataset

$${𝒟}^{1} := {\{ ( {x}_{n}^{1} , {y}_{n}^{1} ) \}}_{n = 1}^{\vert {𝒟}^{1} \vert}$$

may be provided with input data samples xₙ¹ e.g., an image, and corresponding ground-truth labels yₙ¹, yₙ¹ ∈ [symbol] ¹. An initial set

$${P}_{0}^{1} := ( {p}_{0}^{1} , {p}_{0}^{2} , … , {p}_{0}^{\vert {𝒞}^{1} \vert} )$$

of prototype vectors may be provided by executing the “first pass” stage using the input data samples xₙ¹ to the FE 510. After pre-training the classifier using the initial set of prototype vectors as target, a set of updated prototype vectors Pₚ¹ may be determined (e.g., in the first session 501.1 or at the pre-training phase) and stored in the explicit memory 512. The set of prototype vectors

$${P}_{p}^{1} := ( {p}_{1} , {p}_{2} , … , {p}_{\vert {𝒞}^{1} \vert} )$$

may be obtained using the output vectors of the pre-trained FCL 511. For example, for each base class i, the prototype vector pi may be determined as the average of the output vectors of the FCL 511 for input data samples of the base class i. The output vectors may be obtained after the pre-training of the classifier e.g., for each input data sample xₙ¹ of a given base class i the FCL 511 may provide an output vector kₙⁱ that indicates or represents the base class i. Those output vectors kₙⁱ that belong to the same class i may be averaged to obtain the prototype vector pᵢ. Thus, the pre-training in the first phase 500 may result in a pre-trained FE 510 and pre-trained FCL 511. In addition, the EM 512 may store the set of prototype vectors Pₚ¹.

In the following phases 501.1-S which may be referred to as sessions, further training datasets may be received in order to retrain the pre-trained classifier. However, before said further training datasets are processed, the first training dataset [symbol] ¹ may be (re)used in the first session 501.1 to retrain the classifier. Before that, a set of activation vectors

$${A}^{1} := ( {a}_{1} , {a}_{2} , … , {a}_{\vert {𝒞}^{1} \vert} )$$

may also be determined by averaging per class the feature vectors which are outputs by the pre-trained FE 510 in response to receiving input samples of the first training dataset [symbol] ¹. The GAAM 513 may be filled with the averaged activation vectors A¹ of the base classes [symbol] ¹. For example, the activation vector may be provided as follows. The pre-trained FE 510 may receive the input data samples xₙ¹ and provide corresponding extracted feature vectors f_{θ}_{₁}(xₙ¹). The feature vectors of each class i of the set of base classes [symbol] ¹ may be averaged to obtain an activation vector aᵢ which is stored in the GAAM 513. For retraining the classifier, the pretrained FE 510 is frozen and the EM 512 is frozen as indicated by dashed boxes in the sessions 501.1-S. The EM 512 is frozen with an updated set of prototype vectors K* that is obtained from the prototype vectors obtained in the first phase as follows: K*=sign(Pₚ¹).

In the first session 501.1, the retraining occurs in two stages 503.1 and 505.1. In the first stage 503.1, the FCL 511 is retrained with the samples of the first training dataset [symbol] ¹. The retraining of the FCL 511 may be performed as follows. The FCL 511 may receive as input all stored activation vectors aᵢ associated with the base classes [symbol] ¹ in order to be retrained using as target the prototype vectors K*. The retraining of the FCL 511 may be performed such that a distance between output vectors of the FCL 511 and corresponding prototype vectors in the EM 512 is minimized. For that, the minimization may be performed using the following equation over a number T of iterations:

$${θ}_{2}^{( t + 1 )} = {θ}_{2}^{( t )} - β \frac{\partial ( {ℒ}_{F} ( {θ}_{2}^{( t )} , {K}^{*} , {A}^{s} ) )}{\partial {θ}_{2}^{( t )}} ,$$

where [symbol] _{F}=−Σᵢ₌₁^{c}sₕ(kᵢ*, g_{θ}_{₂}_{^{(t)}}(aᵢ), where kᵢ* is the prototype vector stored in the explicit memory 512 in association with the i^{th} class, aᵢ is the input vector of the FCL 511 for the i^{th} class. After retraining of the FCL 511, the second stage 505.1 comes into play. In the second stage 505.1. the retrained FCL 511 is frozen as indicated in FIG. 5 and the EM 512 may be updated using the re-trained classifier. The final prototype vectors P¹ are determined by passing the activation vectors in the GAAM 513 through the retrained FCL 511 one last time in order to obtain the prototype vectors as follows: pᵢ¹=g_{θ}_{₂}_{^{(T)}}(aᵢ). The final prototype vectors P¹ are stored in the EM 512 and used as the current content of the EM 512 in the next session.

After the first session 501.1 is completed, in each further s^{th} session 501.s, the classifier may be retrained with a new received training dataset

$${𝒟}^{s} := {\{ ( {x}_{n}^{s} , {y}_{n}^{s} ) \}}_{n = 1}^{\vert {𝒟}^{s} \vert} .$$

In each further session, the retraining is done in two stages 503.s and 505.s in a similar way as described with the first session 501.1. For example, in the second session i.e., s=2, the EM 512 may be initialized with the set of prototype vectors

$$( {p}_{0}^{1} , {p}_{0}^{2} , … , {p}_{0}^{\vert {𝒞}^{2} \vert} )$$

and the GAAM 513 may be appended with activation vectors

$${A}^{2} := ( {a}_{1} , {a}_{2} , … , {a}_{\vert {𝒞}^{2} \vert} )$$

This may be performed by providing as input the samples xₙ² of the training dataset [symbol] ² to the frozen FE 510, and the retrained FCL 511 may use the activation vectors A² as inputs and provide output vectors which may be averaged per class to obtain set of prototype vectors

$$( {p}_{0}^{1} , {p}_{0}^{2} , … , {p}_{0}^{\vert {𝒞}^{2} \vert} ) .$$

The current content P₀² of the EM 512 may comprise

$${P}_{o}^{2} := ( {p}_{1} , {p}_{2} , … , {p}_{\vert {𝒞}^{1} \vert} , {p}_{0}^{1} , {p}_{0}^{2} , … , {p}_{0}^{\vert {𝒞}^{2} \vert} ) .$$

Prototype vectors K* may be obtained using the sign function, e.g., K*=sign(P₀²). The FCL 511 may be retrained using the training datasets [symbol] ¹ and [symbol] ² using as targets the current content of the EM 512, namely containing the set of prototype vectors K*. The FCL 511 may be retrained with the activation vectors in the GAAM 513 which represent all processed classes, namely [symbol] ¹ and [symbol] ². After the FCL 511 is retrained, the EM 512 may be updated again as described above with the first session to obtain the set of prototype vectors P². These two stages of the retraining may be repeated for each received training dataset. It is to be noted that the classes of the different training datasets may be mutually exclusive across different training datasets, i.e., ∀i≠j, [symbol] ⁱ ∩ [symbol] ^{j}=∅, where [symbol] ¹ may be the set of base classes, and ∀j≠1, [symbol] ^{j} may be a set of novel classes.

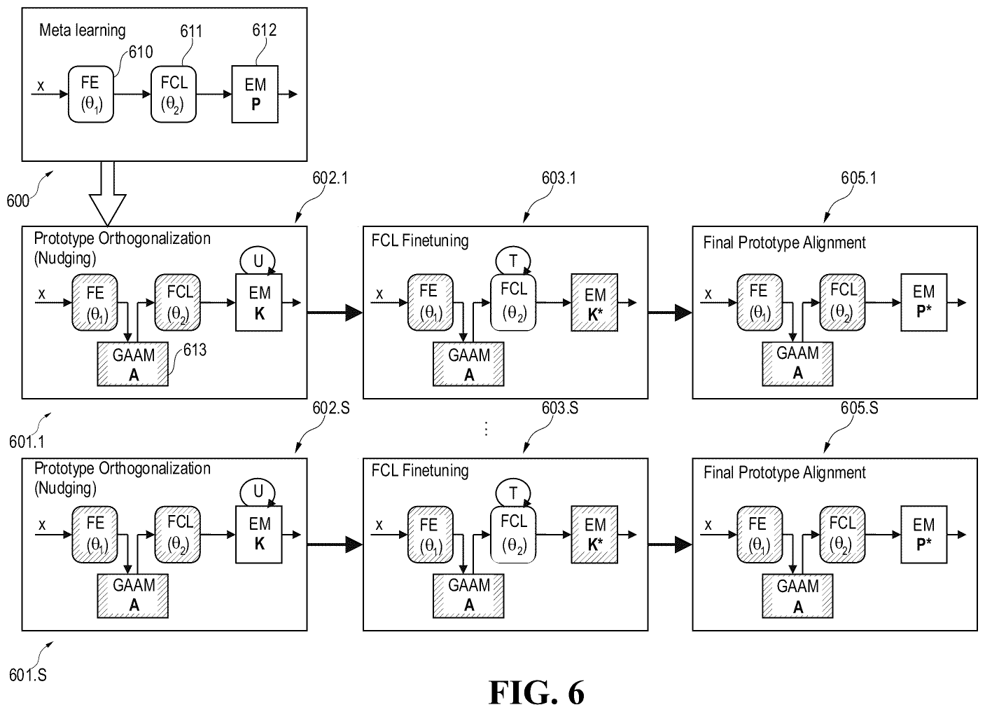

FIG. 6 is a diagram illustrating the stages involved in a method for few shot continual learning of a classifier according to an example of the disclosure.

The classifier comprises a feature extractor (FE) 610 which may be the nonlinear layers of a CNN, a final fully connected layer (FCL) 611 of the CNN and an explicit memory (EM) 612. The FE 610 may have trainable parameters θ₁. The FCL 611 may have the trainable parameters θ₂. The EM 612 may be configured to store prototype vectors representing classes. The training of the classifier according to the present example may be performed in different phases, a first phase 600 followed by a succession of phases 601.1 to 601.S. The classifier may be provided with an additional memory GAAM 613 that may be used for training in the phases 601.1 to 601.S.

In the first phase 600, the classifier may be pre-trained or meta learned using a first training dataset [symbol] ¹ comprising data samples of a set of base classes [symbol] ¹. For example, the first training dataset

$${𝒟}^{1} := {\{ ( {x}_{n}^{1} , {y}_{n}^{1} ) \}}_{n = 1}^{\vert {𝒟}^{1} \vert}$$

may be provided with input data samples xₙ¹ e.g., an image, and corresponding ground-truth labels yₙ¹, yₙ¹ ∈ [symbol] ¹. An initial set

$${P}_{0}^{1} := ( {p}_{0}^{1} , {p}_{0}^{2} , … , {p}_{0}^{\vert {𝒞}^{1} \vert} )$$

of prototype vectors may be provided by executing the “first pass” stage using the input data samples xₙ¹ to the FE 610. After pre-training the classifier using the initial set of prototype vectors as target, a set of prototype vectors Pₚ¹ may be determined and stored in the explicit memory 612 (e.g., in the first session 601.1 or at the pre-training phase). The set of prototype vectors

$${P}_{p}^{1} := ( {p}_{0}^{1} , {p}_{0}^{2} , … , {p}_{\vert {𝒞}^{1} \vert} )$$

may be obtained using the output vectors of the pre-trained FCL 611. For example, for each base class i, the prototype vector pᵢ may be determined as the average of the output vectors of the pre-trained FCL 611 for input data samples of the base class i. The output vectors may be obtained after the pre-training of the classifier e.g., for each input data sample xₙ¹ of a given base class i the FCL 611 may provide an output vector kₙⁱ that indicates or represents the base class i. Those output vectors kₙⁱ that belong to the same class i may be averaged to obtain the prototype vector pᵢ. Thus, the pre-training in the first phase 600 may result in a pre-trained FE 610 and pre-trained FCL 611. In addition, the EM 612 may store the set of prototype vectors Pₚ¹.

In the following phases 601.1-S which may be referred to as sessions, further training datasets may be received in order to retrain the pre-trained classifier. However, before said further training datasets are processed, the first training dataset [symbol] ¹ may be (re)used in the first session 601.1 to retrain the classifier. Before that, a set of activation vectors

$${A}^{1} := ( {a}_{1} , {a}_{2} , … , {a}_{\vert {𝒞}^{1} \vert} )$$

may also be determined by averaging per class the feature vectors which are outputs by the pre-trained FE 510 in response to receiving input samples of the first training dataset [symbol] ¹. The GAAM 513 may be filled with the averaged activation vectors A¹ of the base classes [symbol] ¹. For example, the activation vector may be provided as follows. The pre-trained FE 510 may receive the input data samples xₙ¹ and provide corresponding extracted feature vectors f_{θ}_{₁}(xₙ¹). The feature vectors of each class i of the set of base classes [symbol] ¹ may be averaged to obtain an activation vector aᵢ which is stored in the GAAM 513.

In the first session 601.1, the retraining occurs in three stages 602.1, 603.1 and 605.1. In the first stage 602.1, the FE 610 and the FCL 611 are frozen such that the content of the EM 612 is updated using the first training dataset [symbol] ¹ in order to obtain quasi-orthogonal prototype vectors as the new content K* of the EM 612. The quasi-orthogonal prototype vectors may be referred to as nudged prototype vectors. To obtain the nudged prototype vectors from the current prototype vectors Pₚ¹ stored in the explicit memory 612, the initial nudged prototype vectors may be initialized to the current prototype vectors as follows: K*⁽⁰⁾=Pₚ¹. The nudged prototype vectors are then updated U times in a training loop to find an optimal set of nudged prototype vectors unique to the given activation vectors available in the GAAM 613. The updates to the nudged prototype vectors may be based on two distinct loss functions. In particular, the nudged prototype vectors may be updated using backpropagation on the standard gradient descent algorithm given as:

$${k}_{i}^{* ( u + 1 )} = {k}_{i}^{* ( u )} - α \frac{\partial ( {ℒ}_{O} ( {K}^{* u} ) ) + \partial ( {ℒ}_{M} ( {K}^{* u} , P ) )}{\partial {k}_{i}^{* ( u )}} ,$$

where [symbol] _{O}=Σ_{i,j=1;i≠j}^{c}exp(sₕ(kᵢ*^{(U)}, kᵢ*^{(U)})) and [symbol] _{M}=−Σᵢ₌₁^{c}sₕ(kᵢ*^{(U)}, pᵢ), where kᵢ*^{(u)} is the quasi-orthogonal prototype vector obtained in iteration number u for the i^{th} class, and pᵢ is the prototype vector stored in the explicit memory in association with the i^{th} class, and sₕ denotes a soft hamming distance. The final nudged prototype vectors K*:=K*^{(U)} may be stored in the EM 612 that may be frozen for the next stage 603.1.

In the second stage 603.1, the FCL 611 is not frozen as it may be retrained with the samples of the first training dataset [symbol] ¹. The retraining of the FCL 611 may be performed as follows. The FCL 611 may receive as input all stored activation vectors aᵢ associated with the base classes [symbol] ¹ in order to be retrained using as target the prototype vectors K*. The retraining of the FCL 611 may be performed such that a distance between output vectors of the FCL 611 and corresponding prototype vectors in the EM 612 is minimized. For that, the minimization may be performed using the following equation over a number T of iterations:

$${θ}_{2}^{( t + 1 )} = {θ}_{2}^{( t )} - β \frac{\partial ( {ℒ}_{F} ( {θ}_{2}^{( t )} , {K}^{*} , {A}^{s} ) )}{\partial {θ}_{2}^{( t )}} ,$$

where [symbol] _{F}=−Σᵢ₌₁^{c}sₕ(kᵢ*, g_{θ}_{₂}_{^{(t)}}(aᵢ), where kᵢ* is the prototype vector stored in the explicit memory 612 in association with the i^{th} class, aᵢ is the input vector of the FCL 611 for the i^{th} class.

In the third stage 605.1, the retrained FCL 611 is again frozen, and the EM 612 may be updated using the re-trained classifier. The final prototype vectors P¹ are determined by passing the activation vectors A¹ in the GAAM 613 through the retrained FCL 611 one last time in order to obtain the prototype vectors as follows: pᵢ¹=g_{θ}_{₂}_{^{(T)}}(aᵢ). The final prototype vectors P¹ are stored in the EM 612 and used as the current content of the EM 612 in the next session. The FCL 611 was already fine-tuned on the quasi-orthogonal bipolarized prototypes and therefore these final generated prototypes may also tend to be quasi-orthogonal. Moreover, the final prototypes may provide a better alignment than the bipolarized prototypes.

After the first session 601.1 is completed, in each further s^{th} session 601.s, the classifier may be retrained with a new received training dataset

$${𝒟}^{s} := {\{ ( {x}_{n}^{s} , {y}_{n}^{s} ) \}}_{n = 1}^{\vert {𝒟}^{s} \vert} .$$

In each further session, the retraining is done in three stages 602.s. 603.s and 605.s in a similar way as described with the first session 601.1. For example, in the second session i.e., s=2, the EM 612 may be initialized with the set of prototype vectors

$$( {p}_{0}^{1} , {p}_{0}^{2} , … , {p}_{0}^{\vert {𝒞}^{2} \vert} )$$

and the GAAM 613 may be appended with activation vectors

$$( {a}_{1} , {a}_{2} , … , {a}_{\vert {𝒞}^{2} \vert} ) .$$

This may be performed by providing as input the samples xₙ² of the training dataset [symbol] ² to the frozen FE 610, and the retrained FCL 611 may use the activation vectors

$$( {a}_{1} , {a}_{2} , … , {a}_{\vert {𝒞}^{2} \vert} )$$

as inputs and provide output vectors which may be averaged per class to obtain set of prototype vectors

$$( {p}_{0}^{1} , {p}_{0}^{2} , … , {p}_{0}^{\vert {𝒞}^{2} \vert} ) .$$

The current content of the EM 612 may comprise

$${P}_{o}^{2} := ( {p}_{1} , {p}_{2} , … , {p}_{\vert {𝒞}^{1} \vert} , {p}_{0}^{1} , {p}_{0}^{2} , … , {P}_{0}^{\vert {𝒞}^{2} \vert} ) .$$

The current content EM 612 may be updated in stage 602.2 with nudged prototype vectors which are obtained using the current dataset [symbol] ² but also the previous dataset [symbol] ¹. The GAAM 613 may have the activation vectors for all so far received datasets [symbol] ¹ and [symbol] ². The new nudged prototype vectors that represent classes [symbol] ¹ and [symbol] ² may be obtained as described with reference to stage 602.1 of the first session 601.1. Furthermore, the FCL 611 may be retrained in stage 603.2 using the training datasets [symbol] ¹ and [symbol] ² and using as targets the current content of nudged vectors of the EM 612. The FCL 611 may be retrained with the activation vectors in the GAAM 613 which represent all processed classes namely [symbol] ¹ and [symbol] ². After the FCL 611 is retrained, the EM 612 may be updated again in stage 605.2 as described above with the first session. These three stages of the retraining may be repeated for each received training dataset. It is to be noted that the classes of the different training datasets may be mutually exclusive across different training datasets, i.e., ∀i≠j, [symbol] ⁱ ∩ [symbol] ^{j}=∅, where [symbol] ¹ may be the set of base classes, and ∀j≠1, [symbol] ^{j} may be a set of novel classes.

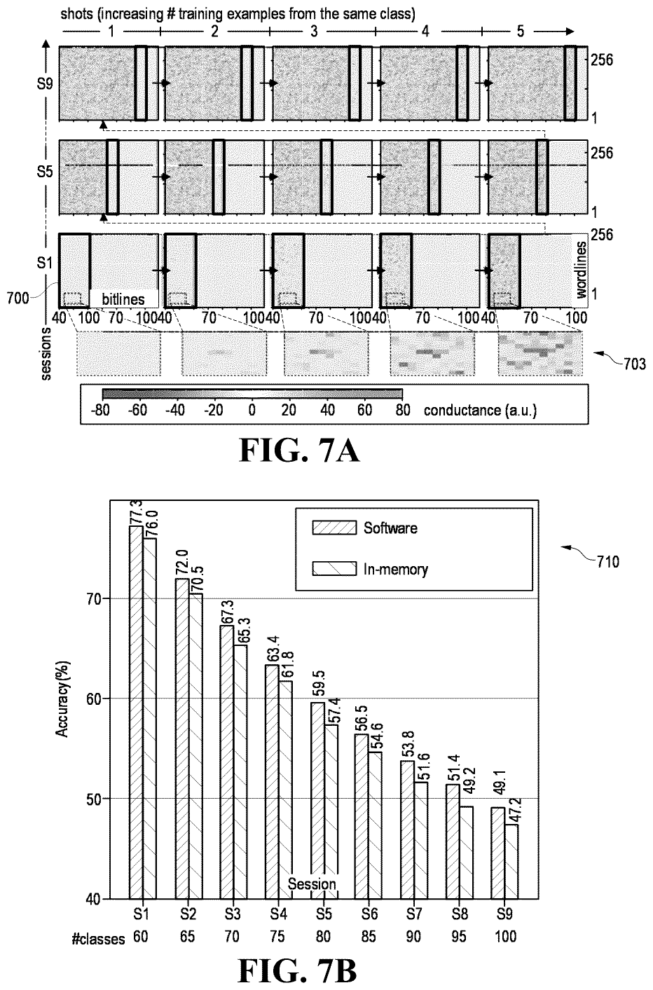

FIG. 7A depicts the status of an in-memory core during different training sessions of the classifier.

The in-memory core may, for example, comprise a crossbar array structure 700 comprising row lines (or wordlines) and column lines (or bitlines) and resistive memory elements coupled between the row lines and the column lines at junctions formed by the row and column lines. The columns of the crossbar array structure 700 are programmed using progressive crystallization scheme such that prototype vectors (e.g., with dimension d=256) corresponding to few training example prototypes are accumulated in-situ. Output vectors may directly be written to the crossbar using the progressive crystallization scheme, exploiting the fact that crystallization acts as a summation function. In the end, the prototype vectors which are average (or summed) version of the output vectors per class are internally prepared e.g., no need to externally compute the average and write. Each column of the crossbar array structure 700 may be associated with respective class. In this example, results are obtained after the classifier is meta-learned on base classes and evaluated through series of sessions first involving base classes and later sessions involving novel classes. Each session of novel classes includes 5 shots per novel class and 5 novel classes i.e., | [symbol] ⁱ|=5, for i>1. The data samples of the training datasets may be images from CIFAR100 database.

As shown in FIG. 7A, in the session number 5, S5, the 5 novel classes are processed successively, such that for each novel class, the corresponding prototype vector is determined using the pre-trained classifier and the column associated with that class is programmed with the determined prototype vector. FIG. 7A shows the status of the conductance map 703 while the prototype vectors are being programmed for each class.

After the crossbar array structure 700 is programmed with the prototype vectors of the classes, a similarity search between query vector and prototype vectors may be performed using in-memory MVM. FIG. 7B shows a plot 710 of the accuracy of classification using the crossbar array structure 700 at each session and using a software-based solution. The plots show that the results are comparable, however, the in-memory provides further advantages such as speed of computation compared to the software-based solution.

Computing environment 800 contains an example of an environment for the execution of at least some of the computer code involved in performing the inventive methods, such as continual classifier's learning code 900. In addition to continual classifier's learning code 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and continual classifier's learning code 900, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

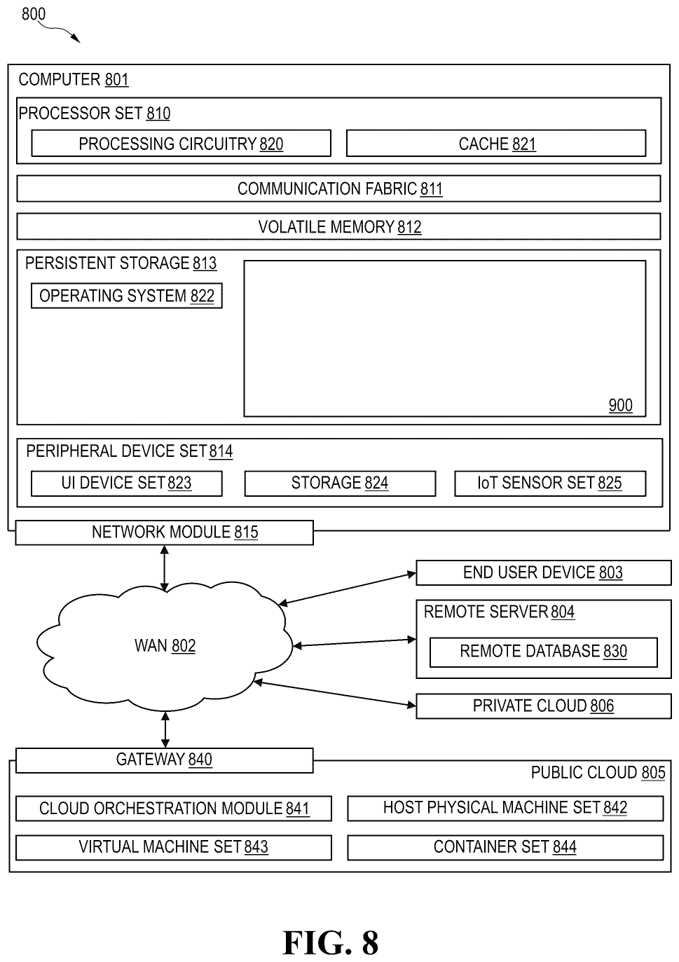

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational stages to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be included in continual classifier's learning code 900 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in continual classifier's learning code 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present. the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated stage, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation or garbage collection, but this does not render the storage device as transitory because the data is not transitory while it is stored.

1. A method for continual training of a classifier, the classifier comprising a controller and an explicit memory, the method comprising:
pre-training the classifier using a first training dataset comprising first data samples of a set of one or more associated base classes;
using a set of first output vectors provided by the controller, in response to the controller receiving the first training dataset, to determine one or more prototype vectors indicative of the set of one or more associated base classes;
storing the one or more prototype vectors in the explicit memory;
receiving one or more second training datasets, each comprising second data samples of a set of one or more associated novel classes;
adding to the explicit memory one or more second output vectors indicative of the set of one or more associated novel classes, in response to providing the one or more second training datasets to the classifier;
retraining the classifier using the one or more second training datasets and the first training dataset by minimizing a distance between the one or more second output vectors and the one or more prototype vectors;
determining a set of updated prototype vectors indicative of first training dataset and the one or more second training datasets; and
updating the explicit memory with the set of updated prototype vectors.

2. The method of claim 1, wherein the controller comprises a feature extractor and a classification head.

3. The method of claim 2, wherein the feature extractor receives the first data sample and provides a first extracted feature vector, and wherein the classification head receives the first extracted feature vector and provides the set of first output vectors to indicate the one or more associated base classes of the first data sample.

4. The method of claim 3, wherein the controller is a convolutional neural network controller comprising multiple nonlinear layers for the feature extractor and the classification head being an output layer of the convolutional neural network.

5. The method of claim 4, wherein the retraining the classifier comprises:
inferring the feature extractor using the second training datasets and storing in an activation memory second extracted feature vectors of each of the second data samples of the second training datasets;
training the classification head using all stored extracted feature vectors; and
wherein the training of the classification head is performed by minimizing a distance between the one or more second output vectors and the set of updated prototype vectors.

6. The method of claim 5, wherein the multiple nonlinear layers with parameter set θ₁ and the classification head with the parameter set θ₂ produce the one or more second output vectors and predicts a probability p over a combined set of the set of one or more associated base classes and the set of one or more associated novel classes, wherein the distance between the one or more second output vectors and the updated prototype vectors is minimized by using:
$${θ}_{2}^{( t + 1 )} = {θ}_{2}^{( t )} - β \frac{\partial ( {ℒ}_{F} ( {θ}_{2}^{( t )} , {K}^{*} , A ) )}{\partial {θ}_{2}^{( t )}} ,$$
where [symbol] _{F}=−Σᵢ₌₁^{c}sₕ(kᵢ*, g_{θ}_{₂}_{^{(t)}}(aᵢ), where kᵢ* is the updated prototype vectors in association with an i^{th} class, and aᵢ is an associated extracted feature vector of the classification head for the i^{th} class.

7. The method of claim 6, wherein the one or more prototype vectors p* * * is defined for the i^{th} class as follows: p*ᵢ=g_{θ}_{₂}_{^{(T)}}(aᵢ).

8. The method of claim 1, further comprising: prior to retraining the classifier, modifying the one or more prototype vectors thereby determining associated quasi-orthogonal prototype vectors and resultantly updating the explicit memory with the quasi-orthogonal prototype vectors.

9. The method of claim 8, wherein determining the quasi-orthogonal prototype vectors comprises backpropagation using a loss function as follows: by
$${k}_{i}^{( u + 1 )} = {k}_{i}^{( u )} - α \frac{\partial ( {ℒ}_{O} ( {K}^{u} ) ) + \partial ( {ℒ}_{M} ( {K}^{u} , P ) )}{\partial {k}_{i}^{( u )}} ,$$
where
$$ℒ𝒪 = , = 1 𝒪 = {O}_{} = {\sum }_{i , j = 1 ; i \neq j}^{c} exp ( {s}_{h} ( {k}_{i}^{( U )} , {k}_{i}^{( U )} ) ) , = 1 ; \neq c e {( ( 𝒰 , 𝒰 ) )}_{O} = {\sum }_{i , j = 1 ; i \neq j}^{c} exp ( {s}_{h} ( {k}_{i}^{( U )} , {k}_{i}^{( U )} ) ) ; \neq c e {( ( 𝒰 , 𝒰 ) )}_{O} = {\sum }_{i , j = 1 ; i \neq j}^{c} exp ( {s}_{h} ( {k}_{i}^{( U )} , {k}_{i}^{( U )} ) ) , = 1 ; \neq c e {( ( 𝒰 , 𝒰 ) )}_{O} = {\sum }_{i , j = 1 ; i \neq j}^{c} exp ( {s}_{h} ( {k}_{i}^{( U )} , {k}_{i}^{( U )} ) ) and {ℒ}_{M} = - {\sum }_{i = 1}^{c} {s}_{h} ( {k}_{i}^{( U )} , {p}_{i} ) ,$$
where kᵢ^{(u)} is an quasi-orthogonal prototype vector obtained in iteration number u for the i^{th} class, and pᵢ is a prototype vector stored in the explicit memory in association with the i^{th} class, and sₕ denotes a soft hamming distance, where the initial quasi-orthogonalized prototypes are given by kᵢ⁽⁰⁾=pᵢ.

10. The method of claim 2, further comprising:
providing an activation memory for accumulating the extracted feature vectors of the feature extractor;
wherein the classification head is configured to receive an input extracted feature vector from the activation memory.

11. The method of claim 1, further comprising:
receiving a query vector; and
performing a similarity search between the query vector and the one or more prototype vectors in the explicit memory for determining a class represented by the query vector.

12. The method of claim 11, further comprising:
providing an in-memory computing core comprising a crossbar array structure comprising row lines and column lines and resistive memory elements coupled between the row lines and the column lines at junctions formed by the row and column lines;
programming the resistive memory elements of each column line to represent values of the one or more prototype vectors; and
inputting to the crossbar array the query vector for performing the similarity search.

13. The method of claim 1, wherein the retraining the classifier is a few shot learning performed upon the set of one or more associated novel classes.

14. The method of claim 1, wherein the retraining the classifier comprises retraining a part of the classifier and freezing another pretrained part of the classifier.

15. The method of claim 1, wherein the prototype vector comprises a set of elements each indicating a probability that a respective class of the one or more associated base classes is a class of the one or more prototype vectors.

16. A computer program product comprising a computer-readable storage medium having computer-readable program code embodied therewith, wherein when the computer-readable program code is called by a processor causes the processor to:
pre-train the classifier using a first training dataset comprising first data samples of a set of one or more associated base classes;
use a set of first output vectors provided by the controller, in response to the controller receiving the first training dataset, to determine one or more prototype vectors indicative of the set of one or more associated base classes;
store the one or more prototype vectors in the explicit memory;
receive one or more second training datasets, each comprising second data samples of a set of one or more associated novel classes;
add to the explicit memory one or more second output vectors indicative of the set of one or more associated novel classes, in response to providing the one or more second training datasets to the classifier;
retrain the classifier using the one or more second training datasets and the first training dataset by minimizing a distance between the one or more second output vectors and the one or more prototype vectors;
determine a set of updated prototype vectors indicative of first training dataset and the one or more second training datasets; and
update the explicit memory with the set of updated prototype vectors.

17. A computer system for continual training of a classifier, the classifier comprising a controller and an explicit memory, the computer system comprising a processor and a computer-readable storage medium having computer-readable program code embodied therewith, wherein when the computer-readable program code is called by the processor causes the processor to:
pre-train the classifier using a first training dataset comprising first data samples of a set of one or more associated base classes;
use a set of first output vectors provided by the controller, in response to the controller receiving the first training dataset, to determine one or more prototype vectors indicative of the set of one or more associated base classes;
store the one or more prototype vectors in the explicit memory;
receive one or more second training datasets, each comprising second data samples of a set of one or more associated novel classes;
add to the explicit memory one or more second output vectors indicative of the set of one or more associated novel classes, in response to providing the one or more second training datasets to the classifier;
retrain the classifier using the one or more second training datasets and the first training dataset by minimizing a distance between the one or more second output vectors and the one or more prototype vectors;
determine a set of updated prototype vectors indicative of first training dataset and the one or more second training datasets; and
update the explicit memory with the set of updated prototype vectors.

18. The computer system of claim 17, wherein the computer system further comprises:
a crossbar array structure comprising row lines and column lines and resistive memory elements coupled between the row lines and the column lines at junctions formed by the row and column lines, the resistive memory elements of each column line representing values of a respective prototype vector, the crossbar array being configured to receive elements of a query vector through the row lines respectively and to perform a vector matrix multiplication at the crossbar array for computing a similarity of the query vector with the one or more prototype vectors, thereby determining a class of the query vector.
